(19) United States
(12) Patent Application Publication
(10) Pub. No.: US 2020/0120183 A1
(43) Pub. Date: Apr. 16, 2020

(54) METHOD, DEVICE AND PROGRAM PRODUCT FOR ACCESSING BACKUP SERVER THROUGH OFFICE SOFTWARE

(71) Applicant: EMC IP Holding Company LLC, Hopkinton, MA (US)

(72) Inventors: Jun Chen, Shanghai (CN); Weiyang Liu, Shanghai (CN); Yuanyi Liu, Shanghai (CN); Zengjie Zhang, Shanghai (CN); Zhijian Zhang, Shanghai (CN)

(21) Appl. No.: 16/367,429

(22) Filed: Mar. 28, 2019

(30) Foreign Application Priority Data
Oct. 12, 2018 (CN) 201811192253.8

(51) Int. Cl. H04L 29/08; H04L 12/24; H04L 12/58

(52) U.S. Cl. CPC H04L 67/32; H04L 41/22; H04L 51/046; H04L 67/1097; H04L 67/34

(57) ABSTRACT

Embodiments of the present disclosure provide a computer-implemented method, an electronic device and a computer program product. In the method, an electronic device receives, from a user via office software, a request for an operation on a backup server, the electronic device performs the operation associated with the request on the backup server, and the electronic device presents a result of the operation to the user via the office software. The embodiments of the present disclosure can simplify a process for a user to access a backup server.

### CROSS REFERENCE TO RELATED APPLICATIONS

This application claims priority to Chinese Patent Application No. 201811192253.8 filed on Oct. 12, 2018. Chinese Patent Application No. 201811192253.8 is hereby incorporated by reference in its entirety.

### FIELD

Embodiments of the present disclosure generally relate to computer systems or storage systems, and more particularly to a method, an electronic device and a computer program product for accessing a backup server through office software.

### BACKGROUND

Usually, a backup server is used to store backup data or files. For a user of the backup server, especially an enterprise user, it is often necessary to be able to locate content from a large amount of backup data. In order to meet such needs, various means can be employed to access and manage backup data in the backup server.

However, in traditional solutions for accessing a backup server, the available access mechanisms are relatively few and inflexible, which may result in a poor user experience in many scenarios.

### SUMMARY

Embodiments of the present disclosure provide a method, an electronic device and a computer program product for accessing a backup server through office software.

In a first aspect of the present disclosure, there is provided a computer-implemented method. The method comprises receiving, from a user via office software, a request for an operation on a backup server. The method also comprises performing the operation associated with the request on the backup server. The method further comprises presenting a result of the operation to the user via the office software.

In a second aspect of the present disclosure, there is provided an electronic device. The electronic device comprises at least one processor and at least one memory storing computer program instructions. The at least one memory and the computer program instructions are configured to, with the at least one processor, cause the electronic device to receive, from a user via office software, a request for an operation on a backup server. The at least one memory and the computer program instructions are also configured to, with the at least one processor, cause the electronic device to perform the operation associated with the request on the backup server. The at least one memory and the computer program instructions are further configured to, with the at least one processor, cause the electronic device to present a result of the operation to the user via the office software.

In a third aspect of the present disclosure, there is provided a computer program product being tangibly stored on a non-volatile computer-readable medium and comprising machine-executable instructions. The machine-executable instructions, when being executed, cause a machine to perform the method according to the first aspect.

It will be appreciated that the summary section does not intend to indicate essential or important features of embodiments of the present disclosure or to limit the scope of the present disclosure. Other features of the present disclosure will be made apparent by the following description.

### BRIEF DESCRIPTION OF THE DRAWINGS

The above and other objectives, features, and advantages of example embodiments of the present disclosure will become more apparent from the following detailed description with reference to the accompanying drawings, in which the same reference symbols refer to the same elements:

FIG. 1 illustrates a schematic diagram of an example environment in which embodiments of the present disclosure can be implemented.

FIG. 2 illustrates a flow chart of a computer-implemented method according to one or more embodiments of the present disclosure.

FIG. 3 illustrates a schematic diagram of an add-in of office software according to one or more embodiments of the present disclosure.

FIGS. 4A-4D illustrate interfaces in a process of accessing a backup server through office software according to one or more embodiments of the present disclosure.

FIG. 5 illustrates a block diagram of a device which can be used to implement embodiments of the present disclosure.

Throughout all figures, identical or like reference numbers are used to represent identical or like elements.

### DETAILED DESCRIPTION OF EMBODIMENTS

The principles and spirit of the present disclosure are described below with reference to several exemplary embodiments shown in the figures. It should be appreciated that these embodiments are only intended to enable those skilled in the art to better understand and implement the present disclosure, not to limit the scope of the present disclosure in any manner.

In traditional solutions for accessing a backup server, available access manners for a user are relatively few and inflexible, which causes a poor user experience in many scenarios. In particular, all operations on the backup server by the user need to be performed through a web browser. In addition, the user (especially an administrator of the backup server) may need to switch back and forth between different applications, such as the web browser and office software, during the process of accessing the backup server.

Furthermore, the backup server may send a notification message about the backup server to the user via an email, and the user may need to access the backup server in response to the notification message. In this case, the user needs to remember specific content in the notification message and then open the web browser to access a specific record or page of a specific backup server. In this procedure, it may be cumbersome and inconvenient to log into a management system (for example, a virtual appliance) of the backup server through the web browser and then frequently switch between web pages.

In view of the above problems and other potential problems existing in the traditional solutions, embodiments of the present disclosure propose a method, an electronic device, and a computer program product for accessing a backup server through office software. The embodiments of the present disclosure provide a solution to a user, which greatly simplifies an entire process for a user to access a backup server, and thereby improving the user experience. Embodiments of the present disclosure relate to integrating a function for accessing a backup server into office software that is commonly used by a user. In this way, a user may access a backup server directly through office software that is being used, without opening other applications. The embodiments of the present disclosure may be advantageous in scenarios where a user receives a notification message from office software regarding a backup server and then accesses the backup server. The embodiments of the present disclosure are described in detail below with reference to the drawings.

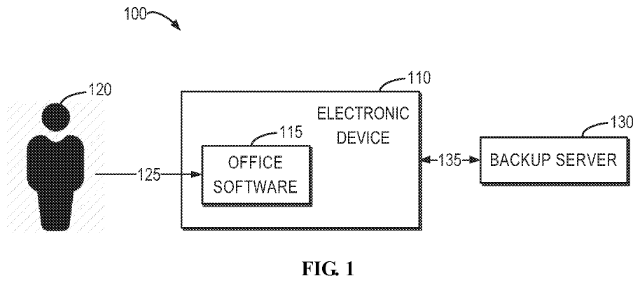

FIG. 1 illustrates a schematic block diagram of an example environment 100 in which embodiments of the present disclosure can be implemented. As shown in FIG. 1, the example environment 100 includes an electronic device 110, a user 120, and a backup server 130. Office software 115 may be executed on the electronic device 110 for use by user 120.

As used herein, the electronic device 110 may refer to any device capable of performing a process associated with various embodiments of the present disclosure. In some embodiments, such a device includes, but is not limited to, a personal computer, a tablet computer, a laptop computer, a notebook computer, a netbook computer, any other type of computer, a cellular or smart phone, a media player device, an e-book device, a mobile WiFi device, a wearable computing device, a wireless device, a mobile device, a user device, and any other type of electronic computing device.

As used herein, the office software 115 may refer to software capable of performing various tasks, such as word processing, table creation, presentation slide creation, graphic image processing, sending/receipt and management of an email, or simple database processing. In some embodiments, such software may include, but is not limited to, word processing software, electronic form creation software, presentation slide creation software, email client software, and the like. In other embodiments, the office software 115 may include any existing and future-developed software suitable for implementing embodiments of the present disclosure.

As used herein, the backup server 130 may refer to a computer for backing up data or files. More generally, the backup server 130 may also include any computer or other computing devices having a data backup function. It will be appreciated that the example environment 100 of FIG. 1 illustrates a specific number of electronic devices and a specific number of backup servers, but these specific numbers are merely exemplary and are not intended to limit the scope of the disclosure in any way. In other embodiments, the example environment 100 may include any suitable number of electronic devices and backup servers, and any proper connections may exist between them.

In an embodiment of the present disclosure, the user 120 can access or manage backup data or files in the backup server 130 via the office software 115. Specifically, the user 120 may send a request 125 for accessing the backup server 130 to the electronic device 110 via the office software 115. Then, based on the request 125 from the user 120, the electronic device 110 may interact with the backup server 130 via a communication connection 135 to access and manage the backup data in the backup server 130.

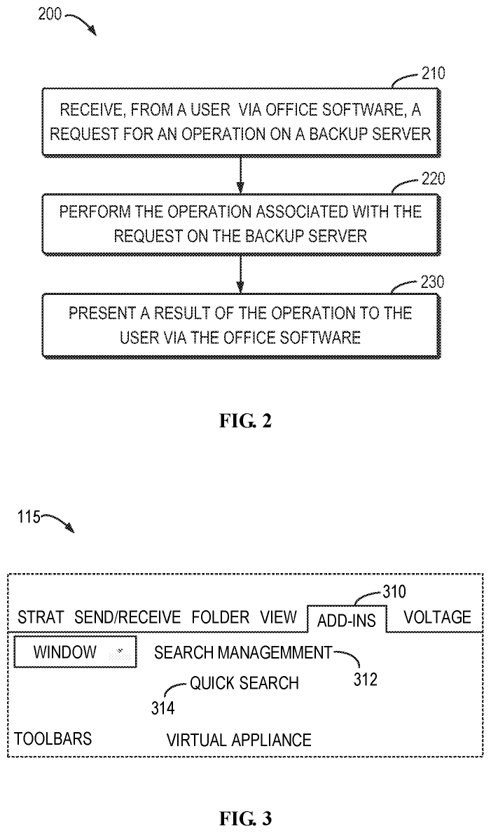

As used herein, the communication connection 135 may generally represent any connection that enables a communication between the electronic device 110 and the backup server 130. In some embodiments, the communication connection 135 may include, but is not limited to, a device for a network connection such as a network card, a hub, a modem, a repeater, a bridge, a switch and a router, and various network connection lines such as a cable and a wireless link. In other embodiments, the communication connection 135 may also include a portion of a computer network or a communication network. The operations associated with the embodiments of the present disclosure are described in more detail below with reference to FIGS. 2-4.

FIG. 2 illustrates a flow chart of a computer-implemented method 200 according to an embodiment of the present disclosure. In some embodiments, the method 200 may be implemented by the electronic device 110 in the example environment 100, for example, by a processor or a processing unit of the electronic device 110, or by various functional modules of the electronic device 110. In the following, for ease of discussion, the method 200 will be discussed by taking an example in which the electronic device 110 implements the method 200 with reference to FIG. 1. However, it will be appreciated that in other embodiments, the method 200 can also be implemented by other electronic devices or computing devices that are external to the example environment 100.

At 210, the electronic device 110 receives the request 125 for an operation on the backup server 130 from the user 120 via the office software 115. For example, the user 120 may need to access backup data in the backup server 130 while using the office software 115. As another example, the user 120 may receive a notification message from the backup server 130 through the office software 115, and need to access the backup server 130 in accordance with the notification message. In these cases, the user 120 may send an operation request 125 associated with the backup server 130 to the electronic device 110 directly via the office software 115.

In some embodiments, the user 120 may need to search for a backup file in the backup server 130, preview a backup file in the backup server 130, download a backup file in the backup server 130, restore a backup file in the backup server 130, obtain information or status of the backup server 130, index a backup file in the backup server 130, and repair a proxy server of the backup server 130, and so on. In other embodiments, the operations intended by the user 120 may include any operations associated with the backup server 130.

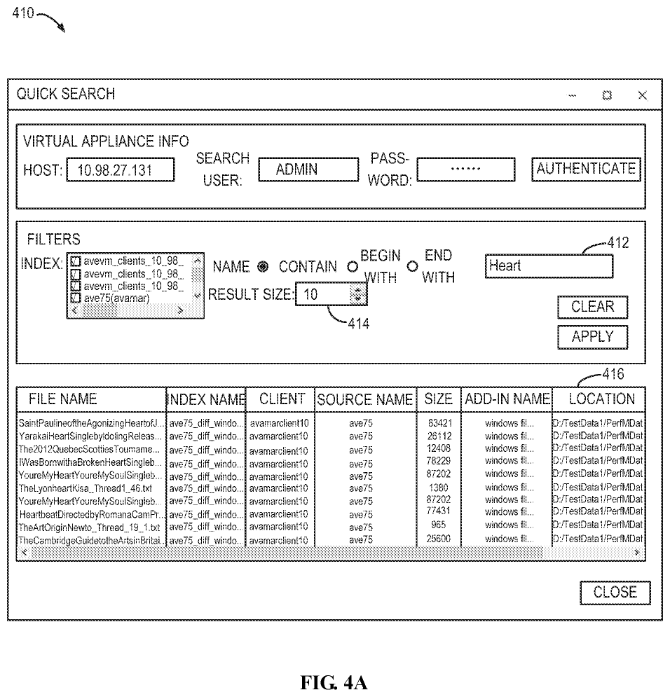

In some embodiments, the electronic device 110 receives the request 125 via an add-in of the office software 115. In this way, the user 120 may perform, in a centralized manner, operations associated with the backup server 130 at a specific location in an operation interface of the office software 115, thereby enabling the user 120 to perform relevant operations on the backup server 130 as if using other functions of the office software 115. In other embodiments, any suitable manner other than the add-in may be used to set an operation entry in the office software 115 for accessing the backup server 130, and embodiments of the present disclosure are not limited to any particular manner. An example of setting an add-in in the office software 115 is specifically described below with reference to FIG. 3.

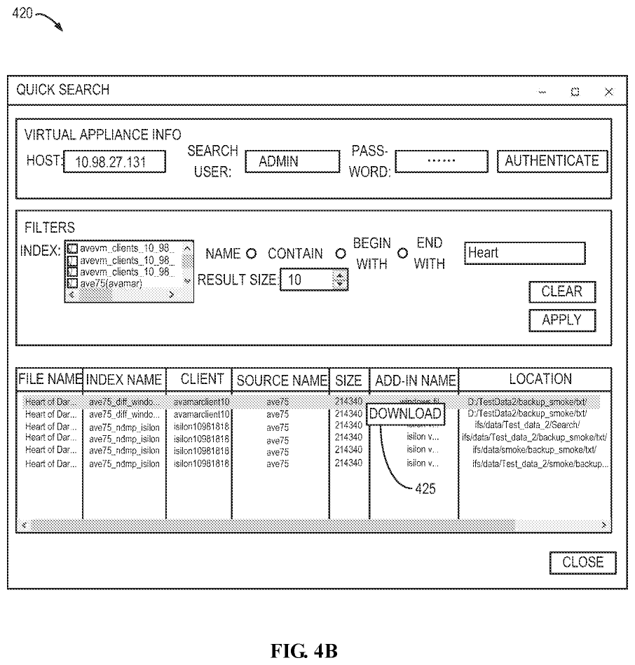

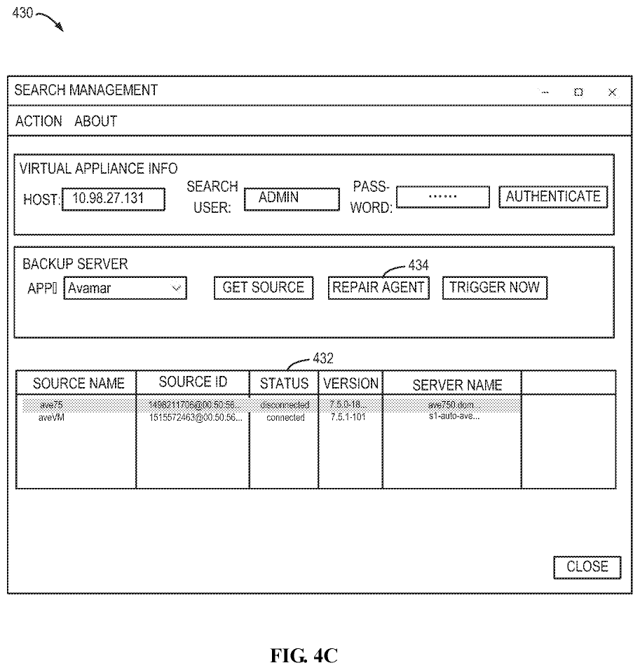

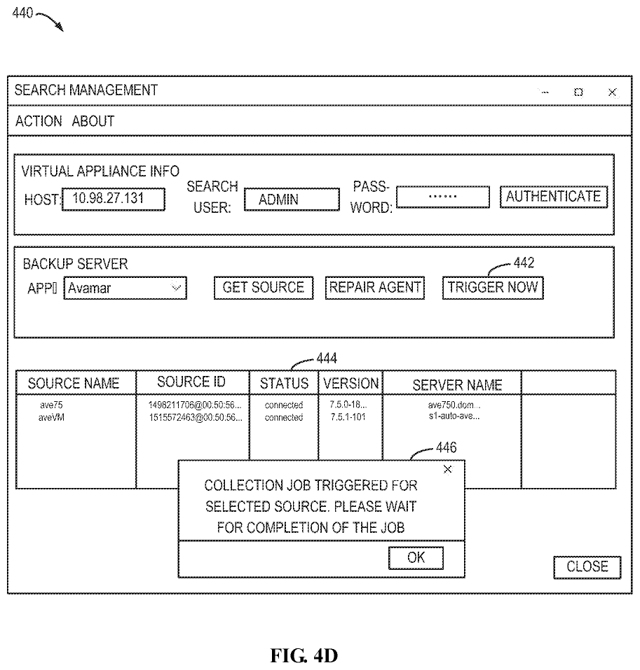

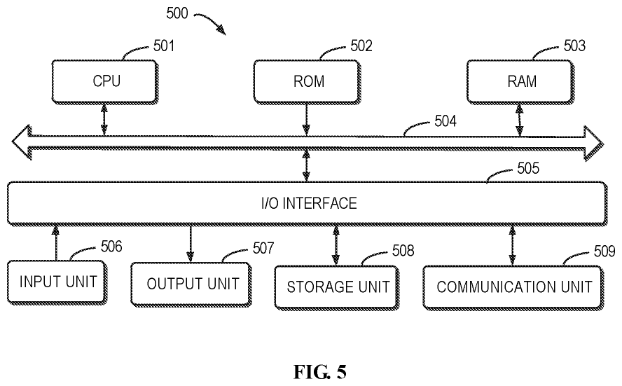

FIG. 3 illustrates a schematic diagram of an add-in 310 of the office software 115 according to an embodiment of the present disclosure. As shown, in order to enable the user 120 to initiate an operation on the backup server 130 directly through the office software 115, the add-in 310 may be added to the office software 115 (for example, a menu bar). Accordingly, the user 120 may select, within the add-in 310, a “Search Management” tab 312 or a “Quick Search” tab 314 corresponding to the intended operation, and then the electronic device 110 may present to the user 120 an interface element related to the operation. Through the interface element, the user 120 may particularly configure parameters of the operation and send the operation request 125 to the electronic device 110. Accordingly, the electronic device 110 receives the request 125 from the user 120 via the interface element. Such an interface element is described below with reference to FIGS. 4A-4D.

FIGS. 4A-4D illustrate interfaces 410-440 in a process of accessing the backup server 130 through the office software 115 according to an embodiment of the present disclosure. As shown in FIG. 4A, the user 120 desires to perform a quick search in the backup server 130, and thus selects the “Quick Search” tag 314 depicted in FIG. 3. In response thereto, the electronic device 110 may present the interface 410 to the user 120 to enable the user 120 to configure, through the interface 410, a specific operational parameter, such as a search condition for the search operation, or the like. In this example, the user 120 sets, in an interface element 412, a character string “Heart” included in a file name to be searched and sets a search result size to be 10 in an interface element 414, so that the electronic device 110 lists ten retrieved file names having a “Heart” in an interface element 416. As shown in FIG. 4B, after finding a file that meets the search condition, the user 120 can also download the retrieved file by clicking on an interface element 425.

As shown in FIG. 4C, the user 120 desires to perform a search management operation in the backup server 130, and thus selects the “Search Management” tab 312 depicted in FIG. 3. In response thereto, the electronic device 110 may present the interface 430 to the user 120 to enable the user 120 to specifically configure the management operation to be performed on the backup server 130 (for example, a source “ave75” in the figure). For instance, in this example, an interface element 435 shows that the backup server 130 is disconnected, so the user 120 may click on an interface element 434 to perform an agent repair operation.

As shown in an interface element 444 of FIG. 4D, the backup server 130 has been restored to a connected state. At this time, the user 120 may also perform a collection operation (namely, indexing the backup data) in the backup server 130, and trigger this management operation by clicking on an interface element 442.

In this way, the user 120 may select the type of operation and set a specific operation parameter in one or more interface-friendly dialog boxes and send the operation request 125 for the backup server 130 to the electronic device 110, thereby improving the efficiency in accessing the backup server 130 by the user 120.

Referring back to FIG. 2, at 220, the electronic device 110 performs the operation associated with the request 125 on the backup server 130. In some embodiments, the backup server 130 may be managed via a virtual appliance that also manages a plurality of other backup servers simultaneously. In this case, the electronic device 110 may invoke the virtual appliance that manages the backup server 130 to perform the operation associated with the request 125.

Specifically, the electronic device 110 may invoke a Representational State Transfer (REST) Application Programming Interface (API) provided by the virtual appliance of the backup server 130. In other embodiments, the electronic device 110 may invoke any suitable type of interface, and embodiments of the present disclosure are not limited to a particular interface. In this way, the electronic device 110 makes full use of powerful functions that have been provided by the virtual appliance managing the backup server 130, without a need to redevelop a new approach for the office software 115 to access the backup server 130. In addition, in other embodiments, the electronic device 110 may also perform an operation on the backup server 130 in other manners other than the virtual appliance.

At 230, the electronic device 110 presents a result of the operation to the user 120 via the office software 115. In some embodiments, the electronic device 110 may pop up a window to the user 120 through the office software 115 to display the result, for example, a window 446 in FIG. 4D. As such, the electronic device 110 may prompt the user 120 of the result of the operation in a manner sufficient to attract the attention of the user 120, to ensure that the user 120 can be aware of the result of the operation. In other embodiments, the electronic device 110 may also provide the result of the operation to the user 120 in any other suitable manners.

In some embodiments, the electronic device 110 may provide a notification message to the user 120 via the office software 115, which notification message may indicate an event associated with backup server 130. By way of example, such an event may include an activity, a problem, and a situation in the backup server 130, or the like. In some embodiments, the office software 115 may include email client software. As such, the backup server 130 may provide the notification message to the user 120 by way of an email.

The advantages and improvements of embodiments of the present disclosure over the traditional solutions are illustrated by a specific use case as below. In this use case, the user 120 receives a notification message through the office software 115 (for example, an email client), where the notification message indicates that a proxy server of the backup server 130 is disconnected. The user 120 may therefore need to trigger a repair of the proxy server.

According to the traditional solutions, the user 120 would need to perform the following steps. The first step is opening a web browser. The second step is logging in the virtual appliance for managing the backup server 130. The third step is reviewing the notification message to determine that the backup server 130 in a plurality of backup servers is in an abnormal state, and specific information about the abnormal state. The fourth step is selecting a management application provided by the virtual appliance according to the specific information. The fifth step is clicking on a “Backup Server” button in the management application to list all the backup servers. The sixth step is locating the specific backup server 130. The seventh step is clicking on a “Repair” button to repair the proxy server of the backup server 130. In general, all of these steps will take approximately 5 minutes and will require switching 3 different operation pages.

In contrast, through embodiments of the present disclosure, the user 120 only needs to select the management application provided by the virtual appliance, list all the backup servers, locate the particular backup server 130, as well as trigger the repair of the proxy server, within the office software 115 (for example, by clicking on an add-in). In this way, the entire process generally only needs to take about 1 minute, without a need to switch the operation pages.

Accordingly, embodiments of the present disclosure have at least the following technical advantages over the traditional solutions. For a scenario where a user is using office software, if the user needs to search for a backup file in a backup server, the user may conveniently and quickly initiate a search directly through the office software. In addition, the user may also download a backup file from the backup server through the office software if necessary.

In addition, if a notification message about a problem with the backup server is received from the office software, the user may immediately initiate a repair of the backup server via the office software, thereby repairing the backup server more efficiently. For example, once an indexing operation in the backup server fails, the user may immediately trigger re-indexing via the office software. In addition, the user may obtain information and status of the backup server more quickly and easily through the office software.

Through the above technical advantages, embodiments of the present disclosure may assist the user in completing some routine work for the backup server within the office software. Embodiments of the present disclosure will improve the user experience in fast tasks like searching or re-running management work (collection, agent repair, or the like). Embodiments of the present disclosure may help an administrator to respond more quickly and efficiently after receiving a failure message of the backup server.

In addition to the web browser, embodiments of the present disclosure provide a user with an alternative entry to a virtual appliance. The integration of a virtual appliance and office software will provide the user with a better experience in routine traditional tasks. As compared with a usual process of accessing the backup server, this significantly improves the user's working efficiency and provides the user with a more consistent and user-familiar user interface (UI). Therefore, embodiments of the present disclosure not only save operating time of an administrator user, but also improve a degree of satisfaction of an ordinary user.

That is to say, embodiments of the present disclosure significantly reduce the operational steps of various types of users in daily accessing to the backup server, thereby improving the work efficiency of various types of users. Moreover, embodiments of the present disclosure use a user interface style of the office software that is more familiar and friendly for the user. For example, embodiments of the present disclosure may be implemented in the form of an add-in in existing office software, thereby helping the user of the office software to accomplish a task related to a backup server more quickly and conveniently.

As an example, the add-in implemented in existing office software may support both search and management functions for the backup server. Specifically, in terms of the searching (and downloading) function, the user may specify certain filtering factors such as an index, a result size, and the like. The user may also download a retrieved file to a local computer. In terms of the management function, the user may obtain information and status of all backup servers. The user may trigger an indexing operation for a selected backup server. The user may also trigger an operation of repairing a proxy server for a disconnected backup server.

FIG. 5 illustrates a block diagram of a device 500 which can be used to implement the embodiments of the present disclosure. As shown in FIG. 5, the device 500 comprises a central processing unit (CPU) 501 that may perform various appropriate actions and processing based on computer program instructions stored in a read-only memory (ROM) 502 or computer program instructions loaded from a storage unit 508 to a random access memory (RAM) 503. In the RAM 503, there further store various programs and data needed for operations of the device 500. The CPU 501, ROM 502 and RAM 503 are connected to each other via a bus 504. An input/output (I/O) interface 505 is also connected to the bus 504.

Various components in the device 500 are connected to the I/O interface 505, including: an input unit 506 such as a keyboard, a mouse and the like; an output unit 507 including various kinds of displays and a loudspeaker, or the like; a storage unit 508 including a magnetic disk, an optical disk, and or the like; a communication unit 509 including a network card, a modem, and a wireless communication transceiver, or the like. The communication unit 509 allows the device 500 to exchange information/data with other devices through a computer network such as the Internet and/or various kinds of telecommunications networks.

Various processes and processing described above, for example, method 200, may be executed by the processing unit 501. For example, in some embodiments, the method 200 may be implemented as a computer software program that is tangibly contained in a machine readable medium, for example, the storage unit 508. In some embodiments, a part or the entire of computer program may be loaded and/or mounted onto the device 500 via ROM 502 and/or communication unit 509. When the computer program is loaded to the RAM 503 and executed by the CPU 501, one or more steps of the at least one of the method 200 as described above may be executed.

As used herein, the term “includes” and its variants are to be read as open terms that mean “includes, but is not limited to.” The term “based on” is to be read as “based at least in part on.” The terms “one implementation” and “an implementation” are to be read as “at least one implementation.” The term “another implementation” is to be read as “at least one other implementation.” The terms “first,” “second,” and the like may refer to different or same objects. Other definitions, either explicit or implicit, may be included below.

As used herein, the term “determining” covers a wide variety of actions. For example, “determining” may include operation, computing, processing, exporting, investigating, looking up (for example, looking up in a table, database, or another data structure), ascertaining, and the like. Further, “determining” may include receiving (for example, receiving information), accessing (for example, accessing data in a memory), and the like. Further, “determining” may include parsing, choosing, selecting, establishing, and the like.

It should be noted that, the embodiments of the present invention can be implemented in software, hardware or the combination thereof. The hardware part can be implemented by a special logic; the software part can be stored in a memory and executed by a proper instruction execution system such as a microprocessor or a design-specific hardware. The normally skilled in the art may understand that the above apparatus and method may be implemented with a computer-executable instruction and/or in a processor controlled code, for example, such code is provided on a programmable memory or a data bearer such as an optical or electronic signal bearer.

In addition, although operations of the method of the present method are described in a particular order in the drawings, it does not require or imply that these operations must be performed according to this particular sequence, or a desired outcome can only be achieved by performing all shown operations. On the contrary, the execution order for the steps as depicted in the flowcharts may be varied. Additionally or alternatively, some steps may be omitted, a plurality of steps may be merged into one step, and/or a step may be divided into a plurality of steps for execution. It should also be noted that features and functions of two or more devices in accordance with the present disclosure may be embodied in one device. Conversely, the features and functions of one device described above can be further divided into multiple devices.

Although the present disclosure has been depicted with reference to a plurality of embodiments, it should be understood that the present invention is not limited to the disclosed embodiments. The present disclosure intends to cover various modifications and equivalent arrangements included in the spirit and scope of the appended claims.

1. A computer-implemented method, comprising:
receiving, from a user via office software, a request for an operation on a backup server;
performing the operation associated with the request on the backup server; and
presenting a result of the operation to the user via the office software.

2. The method of claim 1, wherein receiving the request comprises:
receiving the request via an add-in of the office software.

3. The method of claim 2, wherein receiving the request via the add-in of the office software comprises:
in response to the user selecting, within the add-in, a tab corresponding to the operation, presenting to the user an interface element related to the operation; and
receiving the request from the user via the interface element.

4. The method of claim 1, wherein performing the operation comprises:
invoking a virtual appliance managing the backup server to perform the operation.

5. The method of claim 1, wherein presenting the result of the operation comprises:
displaying the result using a popping up window.

6. The method of claim 1, further comprising:
providing to the user, via the office software, a notification message indicating an event associated with the backup server.

7. The method of claim 1, wherein the office software comprises email client software.

8. The method of claim 1, wherein the operation comprises at least one of:
searching for a backup file in the backup server,
previewing a backup file in the backup server,
downloading a backup file in the backup server,
restoring a backup file in the backup server,
obtaining information or status of the backup server,
indexing a backup file in the backup server, and
repairing a proxy server of the backup server.

9. An electronic device, comprising:
at least one processor; and
at least one memory storing computer program instructions, the at least one memory and the computer program instructions being configured to, with the at least one processor, cause the electronic device to:
receive, from a user via office software, a request for an operation on a backup server;
perform the operation associated with the request on the backup server; and
present a result of the operation to the user via the office software.

10. The electronic device of claim 9, wherein the at least one memory and the computer program instructions are further configured to, with the at least one processor, cause the electronic device to:
receive the request via an add-in of the office software.

11. The electronic device of claim 10, wherein the at least one memory and the computer program instructions are further configured to, with the at least one processor, cause the electronic device to:
in response to the user selecting, within the add-in, a tab corresponding to the operation, present to the user an interface element related to the operation; and
receive the request from the user via the interface element.

12. The electronic device of claim 9, wherein the at least one memory and the computer program instructions are further configured to, with the at least one processor, cause the electronic device to:
invoke a virtual appliance managing the backup server to perform the operation.

13. The electronic device of claim 9, wherein the at least one memory and the computer program instructions are further configured to, with the at least one processor, cause the electronic device to:
display the result in a pop up window.

14. The electronic device of claim 9, wherein the at least one memory and the computer program instructions are further configured to, with the at least one processor, cause the electronic device to:
provide to the user, via the office software, a notification message indicating an event associated with the backup server.

15. The electronic device of claim 9, wherein the office software comprises email client software.

16. The electronic device of claim 9, wherein the operation comprises at least one of:
searching for a backup file in the backup server,
previewing a backup file in the backup server,
downloading a backup file in the backup server,
restoring a backup file in the backup server,
obtaining information or status of the backup server,
indexing a backup file in the backup server, and
repairing a proxy server of the backup server.

17. A computer program product being tangibly stored on a non-volatile computer-readable medium and comprising machine-executable instructions which, when being executed, cause a machine to a method, the method comprising:
receiving, from a user via office software, a request for an operation on a backup server;
performing the operation associated with the request on the backup server; and
presenting a result of the operation to the user via the office software.

18. The computer program product of claim 17, wherein receiving the request comprises:
receiving the request via an add-in of the office software.

19. The computer program product of claim 18, wherein receiving the request via the add-in of the office software comprises:
in response to the user selecting, within the add-in, a tab corresponding to the operation, presenting to the user an interface element related to the operation; and
receiving the request from the user via the interface element.

20. The computer program product of claim 17, wherein the operation comprises at least one of:
searching for a backup file in the backup server,
previewing a backup file in the backup server,
downloading a backup file in the backup server,
restoring a backup file in the backup server,
obtaining information or status of the backup server,
indexing a backup file in the backup server, and
repairing a proxy server of the backup server.
